(19) United States
(12) Patent Application Publication
(10) Pub. No.: US 2025/0310223 A1
(43) Pub. Date: Oct. 2, 2025

(54) TRAFFIC STATISTIC INFORMATION ACQUISITION SYSTEM AND METHOD

(71) Applicant: Nippon Telegraph and Telephone Corporation, Tokyo (JP)

(72) Inventors: Yusuke Sekihara, Tokyo (JP); Namiko Ikeda, Tokyo (JP); Hiroyuki Uzawa, Tokyo (JP); Saki Hatta, Tokyo (JP); Shoko Oteru, Tokyo (JP)

(21) Appl. No.: 18/866,016

(22) PCT Filed: Jul. 13, 2022
(86) PCT No.: PCT/JP2022/027579

§ 371 Date: Nov. 14, 2024

(51) Int. Cl. H04L 43/067; H04L 43/026; H04L 43/062

(52) U.S. Cl. CPC H04L 43/067; H04L 43/026; H04L 43/062

(57) ABSTRACT

A traffic statistical information acquisition system includes a plurality of data collection devices that analyze packets flowing on a network to generate traffic statistical information for each fixed aggregation period and to generate traffic variation notification information when detecting the traffic variation, and a data accumulation device that constructs a database based on the traffic statistical information and the traffic variation notification information generated by the plurality of data collection devices.

### CROSS-REFERENCE TO RELATED APPLICATIONS

This application is a national phase entry of PCT Application No. PCT/JP2022/027579, filed on Jul. 13, 2022, which application is hereby incorporated herein by reference.

### TECHNICAL FIELD

The present invention relates to a technique for acquiring traffic statistical information in a network.

### BACKGROUND

It is generally performed to obtain packets flowing in a network and information on the packets in order to grasp a communication status of the network. In particular, it is generally used to collect traffic information in units (a group of packets having a common attribute) of flows called xflow, and visualize the collected information by a device called a collector (see NPL 1).

In addition, in order to acquire more detailed traffic information than xflow, it is general to utilize a filtering technique called a PI (Packet Inspection) for analyzing all packets as a target (see NPL 2).

In a group of techniques called xflow, flow analysis is often performed using sampled data as disclosed in NPL 1. FIG. 7 is a diagram for explaining sampling operation of Netflow which is a kind of xflow. In the Netflow, packets to be aggregated and packets to be discarded are determined at a fixed rate among packets 100 flowing through the network equipment, and statistical information is generated by aggregating information of the sampled packets by a collection device 101. Such an xflow technique represented by the Netflow has advantages such that it is possible to estimate a global traffic status, to realize at a relatively low cost due to the reduced number of arithmetic resources required for the aggregation, and the like. However, these techniques have a problem that it is difficult to analyze short-term traffic variations in a particular high-rate network.

On the other hand, in the analysis technique using the PI, since the inputted packets are analyzed one by one, short-term traffic variation can be analyzed, but an output result is very detailed and large. In addition, a high-level analysis device is generally very expensive. Therefore, it is practically very difficult to arrange a plurality of PI devices to analyze the entire network region from both the viewpoint of arithmetic resources and costs.

### CITATION LIST

### Non Patent Literature

NPL 1 “InMon Corporation's sFlow: A Method for Monitoring Traffic in Switched and Routed Networks”, IETF Network Working Group, Request for Comments 3176, 2001, <https://datatracker.ietf.org/doc/html/rfc3176>
NPL 2 Argha Ghosh, Dr. A. Senthilrajan, “Research on Packet Inspection Techniques”, INTERNATIONAL JOURNAL OF SCIENTIFIC & TECHNOLOGY RESEARCH, vol. 8, ISSUE 11, 2019.

### SUMMARY

### Technical Problem

In order to solve the above problem, embodiments of the present invention are performed, and an object of embodiments of the present invention is to provide a traffic statistical information acquisition system and method capable of achieving both short-term traffic variation detection and efficient network monitoring using a small amount of arithmetic resources.

### Solution to Problem

A traffic statistical information acquisition system of embodiments of the present invention is characterized in that the traffic statistical information acquisition system includes a plurality of data collection devices that configured to be arranged at a plurality of collection points on a network, and to analyze packets flowing on the network to generate traffic statistic information for each fixed aggregation period and to generate traffic variation notification information when detecting the traffic variation, and a data accumulation device configured to construct a database on the basis of the traffic statistical information and the traffic variation notification information generated by the plurality of data collection devices.

### Advantageous Effects

According to embodiments of the present invention, a plurality of data collection devices arranged on a network aggregates traffic statistical information and detects short-term traffic variation, and a data accumulation device constructs a database on the basis of the traffic statistical information and traffic variation notification information generated by the plurality of data collection devices. As a result, embodiments of the present invention can achieve both the short-term traffic variation detection and the efficient network monitoring by a small amount of arithmetic resources.

### BRIEF DESCRIPTION OF THE DRAWINGS

FIG. 1 is a block diagram showing a configuration of a traffic statistical information acquisition system according to an example of the present invention.

FIG. 2 is a block diagram showing a configuration of a data collection device according to the example of the present invention.

FIG. 3 is a flowchart for explaining operations of the data collection device according to the example of the present invention.

FIG. 4 is a block diagram showing a configuration of a data accumulation device according to the example of the present invention.

FIG. 5 is a flowchart for explaining operations of the data accumulation device according to the example of the present invention.

FIG. 6 is a block diagram showing a configuration example of a computer that realizes the data collection device and the data accumulation device according to the example of the present invention.

FIG. 7 is a diagram for explaining sampling operations of Netflow.

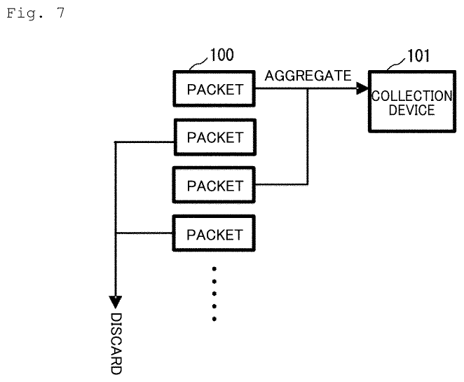

### DETAILED DESCRIPTION OF ILLUSTRATIVE EMBODIMENTS

### Example

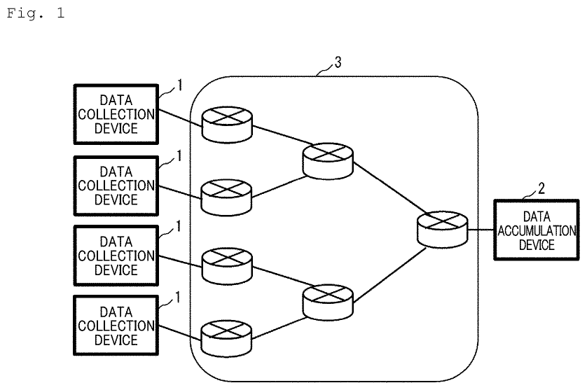

Hereinafter, an example of the present invention will be described with reference to the drawings. FIG. 1 is a block diagram showing a configuration of a traffic statistical information acquisition system according to an example of the present invention. The traffic statistical information acquisition system is configured by a plurality of data collection devices 1 that is arranged at a plurality of collection points on a network 3, and analyzes packets flowing on the network 3 to generate traffic statistical information for each fixed aggregation period and to generate traffic variation notification information when detecting the traffic variation, and a data accumulation device 2 that constructs a database on the basis of the traffic statistical information and the traffic variation notification information generated by the plurality of data collection devices 1.

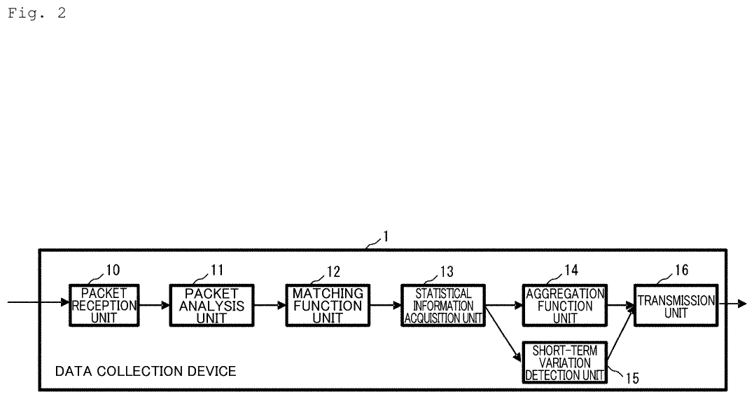

The data collection device 1 is arranged at each of the plurality of collection points on the network 3, and analyzes packets flowing on the network 3. FIG. 2 is a block diagram showing a configuration of the data collection device 1. The data collection device 1 is configured by a packet reception unit 10, a packet analysis unit 11, a matching function unit 12, a statistical information acquisition unit 13, an aggregation function unit 14, a short-term variation detection unit 15, and a transmission unit 16.

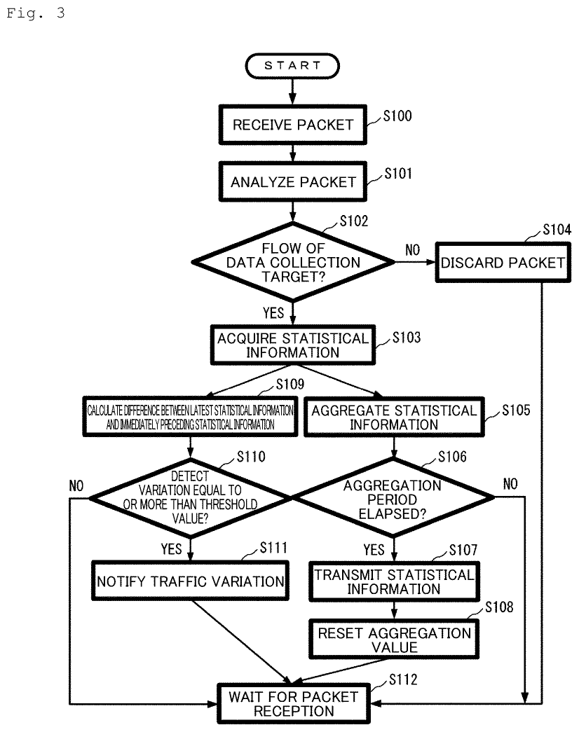

FIG. 3 is a flowchart for explaining operations of the data collection device 1. The packet reception unit 10 receives the packet from the connected network (step S100 in FIG. 3).

The packet analysis unit 11 analyzes headers of the packets received by the packet reception unit 10, and extracts header field information (step S101 in FIG. 3).

The matching function unit 12 identifies whether or not the packet received by the packet reception unit 10 is a packet belonging to a flow of a data collection target on the basis of the field information of the header extracted by the packet analysis unit 11 (step S102 in FIG. 3).

The flow information of the data collection target is registered in advance in the matching function unit 12. For example, a combination of some information among a transmission source MAC (Media Access Control) address, a transmission destination MAC address, a transmission source IP (Internet Protocol) address, a transmission destination IP address, a transmission source port number, a transmission destination port number, a protocol type, a VLAN ID (Virtual Local Area Network IDentifier), and the like is registered in the matching function unit 12 as the flow information of the data collection target. When the flow information of the received packet matches the flow information registered in advance, the matching function unit 12 judges the received packet as a packet belonging to the flow of the data collection target.

The statistical information acquisition unit 13 acquires the traffic statistical information of the packet judged to be the flow of the data collection target by the matching function unit 12 for each flow (step S103 in FIG. 3). The traffic statistical information includes the number of packets, the packet length, and the like. Note that the packet judged not to be the flow of the data collection target is discarded (step S104 in FIG. 3).

The aggregation function unit 14 aggregate the traffic statistical information acquired by the statistical information acquisition unit 13 for each flow (step S105 in FIG. 3). The aggregation function unit 14 aggregates the traffic statistical information for each flow and for each fixed aggregation period, and transmits the aggregated traffic statistical information to the data accumulation device 2 via the transmission unit 16 (step S107 in FIG. 3), when it is judged that the aggregation period has elapsed (Yes in step S106 in FIG. 3). At this time, the aggregation function unit 14 adds a flow ID for uniquely identifying a flow to the traffic statistical information and transmits the traffic statistical information. Then, the aggregation function unit 14 resets the aggregated traffic statistical information to 0 and resets the count value of a timer for measuring the aggregation period to o (step S108 in FIG. 3).

On the other hand, the short-term variation detection unit 15 calculates a difference between the latest traffic statistical information acquired by the statistical information acquisition unit 13 and the immediately preceding traffic statistical information (traffic statistical information obtained from a packet received last time) for each flow (step S109 in FIG. 3). Thus, the degree of increase in the traffic statistical information in a short period can be calculated. When the latest traffic statistical information is largely increased and the difference between the latest traffic statistical information and the immediately preceding traffic statistical information exceeds a predetermined threshold value (Yes in step S110 in FIG. 3), the short-term variation detection unit 15 judges that the short-term traffic variation occurs, and transmits the traffic variation notification information to the data accumulation device 2 via the transmission unit 16 (step S111 in FIG. 3). At this time, the short-term variation detection unit 15 adds a flow ID in which the difference between the latest traffic statistical information and the immediately preceding traffic statistical information exceeds the threshold value to the traffic variation notification information and transmits the traffic variation notification information.

After the processing of steps S100 to S111 is ended, the data collection device 1 waits for the next packet reception (step S112 in FIG. 3).

As described above, the data collection device 1 of the present example is configured to perform packet analysis and addition/subtraction of the traffic statistical information, does not require a large-capacity database or advanced functions, and can be realized by using a small amount of arithmetic resources and hardware without high-level server functions and expensive server resources.

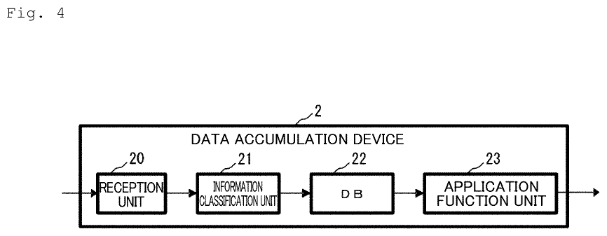

FIG. 4 is a block diagram showing a configuration of the data accumulation device 2. The data accumulation device 2 is configured by a reception unit 20, an information classification unit 21, a database (DB) 22, and an application function unit 23.

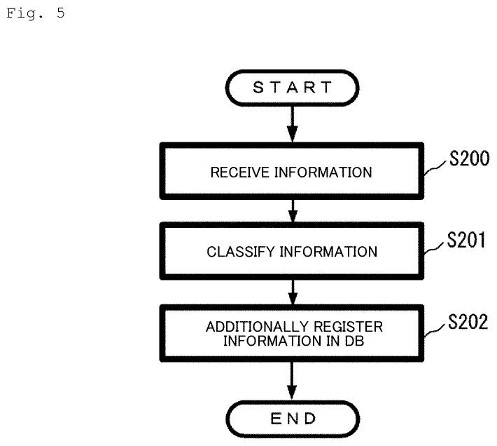

FIG. 5 is a flowchart for explaining operations of the data accumulation device 2. The reception unit 20 receives the traffic statistical information and the traffic variation notification information transmitted from the data collection device 1 (step S200 in FIG. 5).

The information classification unit 21 classifies the traffic statistical information and the traffic variation notification information received by the reception unit 20 by flow (step S201 in FIG. 5). As described above, since the flow ID is added to the traffic statistical information and the traffic variation notification information, the information can be classified on the basis of the flow ID.

The information classification unit 21 additionally registers the classified information in the DB 22 (step S202 in FIG. 5). At this time, the information classification unit 21 additionally registers the classified information in the DB by corresponding flow and additionally registers it in the DB corresponding to the entire network.

Thus, the application function unit 23 can read and use the traffic statistical information and the traffic variation notification information registered in the DB 22. Note that, in embodiments of the present invention, the application function unit 23 utilizing information is not limited, and an arbitrary application function unit 23 can be implemented on the data accumulation device 2 or an external device.

Since the data accumulation device 2 of the present example inputs the information generated by the data collection device 1, it does not require a packet analysis function. In addition, since the traffic statistical information sent from the data collection device 1 is an aggregation value for a fixed time on the assumption it is made into a database in the data accumulation device 2, it is not necessary to hold the information received in the data accumulation device 2 for the aggregation, and the database expressing the communication status of the network can be constructed only by adding the received information to the database sequentially.

As described above, in the present example, the data collection device 1 captures the short-term traffic variations and the data accumulation device 2 constructs the database expressing the behavior of the entire long-term traffic, so that each of the data collection device 1 and the data accumulation device 2 can handle only the data of the required time interval, thus, efficient network monitoring can be realized.

Although the example of the traffic statistical information acquisition system of embodiments of the present invention has been described above, the present invention is not limited to the example, and various configuration modifications can be made without departing from the scope of the present invention.

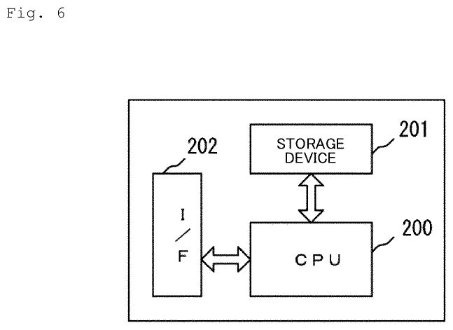

The data collection device 1 and the data accumulation device 2 described in the present example can be realized by a computer including a CPU (Central Processing Unit), a storage device, and an interface, and a program that controls these hardware resources, respectively. FIG. 6 shows a configuration example of the computer.

The computer includes a CPU 200, a storage device 201, and an interface device (I/F) 202. A communication circuit for connecting to the network 3 is connected to each I/F 102 of the data collection device 1 and the data accumulation device 2. In such a computer, the program for realizing the traffic statistical information acquisition method of embodiments of the present invention is stored in the storage device 201. Each CPU 200 of the data collection device 1 and the data accumulation device 2 executes the processing described in the present example in accordance with the program stored in the storage device 201. In addition, at least a part of the data collection device 1 and the data accumulation device 2 may be realized by hardware.

Some or all of the above examples may be also described in the following supplements, but are not limited to the following.

### Supplement 1

A traffic statistical information acquisition system of embodiments of the present invention includes a plurality of data collection devices configured to be arranged at a plurality of collection points on a network, and to analyze packets flowing on the network to generate traffic statistical information for each fixed aggregation period and to generate traffic variation notification information when detecting the traffic variation, and a data accumulation device configured to construct a database on the basis of the traffic statistical information and the traffic variation notification information generated by the plurality of data collection devices.

### Supplement 2

The traffic statistical information acquisition system according to supplement 1, wherein the data collection device includes a first reception unit configured to receive the packet from the network, a packet analysis unit configured to analyze the packets received by the first reception unit, a matching function unit configured to identify whether or not the received packet is a packet belonging to a flow of a data collection target on the basis of an analysis result by the packet analysis unit, a statistical information acquisition unit configured to acquire traffic statistical information of the packet judged to be the flow of the data collection target by the matching function unit for each flow, an aggregation function unit configured to aggregate the traffic statistical information acquired by the statistical information acquisition unit for each flow and for each aggregation period, a short-term variation detection unit configured to generate traffic variation notification information when detecting the traffic variation on the basis of the traffic statistical information acquired by the statistical information acquisition unit, and a transmission unit configured to transmit the traffic statistical information and the traffic variation notification information aggregated for each flow to the data accumulation device.

### Supplement 3

The traffic statistical information acquisition system according to supplement 2, wherein the short-term variation detection unit calculates a difference between the latest traffic statistical information acquired by the statistical information acquisition unit and the immediately preceding traffic statistical information for each flow, and judges that the traffic variation occurs when the calculated difference exceeds a predetermined threshold value.

### Supplement 4

The traffic statistical information acquisition system according to supplement 2 or 3, wherein the data accumulation device includes a second reception unit configured to receive the traffic statistical information and the traffic variation notification information transmitted from the data collection device, and an information classification unit configured to classify the traffic statistical information and the traffic variation notification information received by the second reception unit by flow and to additionally register the classified information in the database by corresponding flow.

### Supplement 5

A traffic statistical information acquisition method of embodiments of the present invention includes a first step in which a data collection device analyzes packets flowing on a network at each of a plurality of collection points on the network to generate traffic statistical information for each fixed aggregation period and to generate traffic variation notification information when detecting the traffic variation, and a second step in which a data accumulation device constructs a database on the basis of the traffic statistical information and the traffic variation notification information obtained from the plurality of collection points.

### Supplement 6

The traffic statistical information acquisition method according to supplement 5, wherein the first step includes a third step of receiving the packet from the network, a fourth step of analyzing the packets received in the third step, a fifth step of identifying whether or not the received packet is a packet belonging to a flow of a data collection target on the basis of an analysis result on the fourth step, a sixth step of acquiring traffic statistical information of the packet judged to be the flow of the data collection target in the fifth step for each flow, a seventh step of aggregating the traffic statistical information acquired in the sixth step for each flow and for each aggregation period, an eighth step of generating traffic variation notification information when detecting the traffic variation on the basis of the traffic statistical information acquired in the sixth step, and a ninth step of transmitting the traffic statistical information and the traffic variation notification information aggregated for each flow to the data accumulation device.

### Supplement 7

The traffic statistical information acquisition method according to supplement 6, wherein the eighth step includes a step of calculating a difference between the latest traffic statistical information acquired in the sixth step and the immediately preceding traffic statistical information for each flow, and judging that the traffic variation occurs when the calculated difference exceeds a predetermined threshold value.

### Supplement 8

The traffic statistical information acquisition method according to supplement 6 or 7, wherein the second step includes a tenth step of receiving the traffic statistical information and the traffic variation notification information transmitted from the data collection device, and an eleventh step of classifying the traffic statistical information and the traffic variation notification information received in the tenth step by flow, and additionally registering the classified information in the database by corresponding flow.

### Industrial Applicability

Embodiments of the present invention can be applied to the technique of monitoring the network.

### Reference Signs List

1 Data collection device
2 Data accumulation device
3 Network
10 Packet reception unit
11 Packet analysis unit
12 Matching function unit
13 Statistical information acquisition unit
14 Aggregation function unit
15 Short-term variation detection unit
16 Transmission unit
20 Reception unit
21 Information classification unit
22 Database
23 Application function unit

1-8. (canceled)

9. A traffic statistical information acquisition system comprising:
a plurality of data collection devices configured to be arranged at a plurality of collection points on a network, each of the plurality of data collection devices being configured to analyze packets flowing on the network to generate traffic statistical information for each fixed aggregation period and to generate traffic variation notification information in response to detecting traffic variation; and
a data accumulation device configured to construct a database based on the traffic statistical information and the traffic variation notification information generated by the plurality of data collection devices.

10. The traffic statistical information acquisition system according to claim 9, wherein each of the data collection devices comprises:
a first receiver configured to receive packets from the network;
a packet analysis circuit configured to analyze packets received by the first receiver;
a matching function circuit configured to identify whether or not the packets belong to one or more flows of a data collection target based on an analysis result by the packet analysis circuit;
a statistical information acquisition circuit configured to acquire traffic statistical information of each of the packets belonging to the one or more flows of the data collection target;
an aggregation function circuit configured to aggregate the traffic statistical information acquired by the statistical information acquisition circuit for each of the one or more flows and for each aggregation period;
a short-term variation detection circuit configured to generate traffic variation notification information when detecting the traffic variation based on the traffic statistical information acquired by the statistical information acquisition circuit; and
a transmitter configured to transmit the traffic statistical information and the traffic variation notification information aggregated for each flow to the data accumulation device.

11. The traffic statistical information acquisition system according to claim 10, wherein the short-term variation detection circuit is configured to:
calculate a difference between a latest traffic statistical information acquired by the statistical information acquisition circuit and an immediately preceding traffic statistical information for each of the one or more flows; and
judge that the traffic variation occurs when the difference exceeds a predetermined threshold value.

12. The traffic statistical information acquisition system according to claim 10, wherein the data accumulation device comprises:
a second receiver configured to receive the traffic statistical information and the traffic variation notification information transmitted from the data collection device; and
an information classification circuit configured to classify the traffic statistical information and the traffic variation notification information received by the second receiver for each of the one or more flows and to register the traffic statistical information and the traffic variation notification information in the database by a corresponding flow of the one or more flows.

13. A traffic statistical information acquisition method comprising:
a first step in which a data collection device analyzes packets flowing on a network at each of a plurality of collection points of the network to generate traffic statistical information for each fixed aggregation period and to generate traffic variation notification information in response to detecting traffic variation; and
a second step in which a data accumulation device constructs a database based on the traffic statistical information and the traffic variation notification information obtained from the plurality of collection points.

14. The traffic statistical information acquisition method according to claim 13, wherein the first step comprises:
a third step of receiving packets from the network;
a fourth step of analyzing packets received in the third step;
a fifth step of identifying whether or not the packets belong to one or more flows of a data collection target based on an analysis result in the fourth step;
a sixth step of acquiring traffic statistical information of each of the packets belonging to the one or more flows of the data collection target;
a seventh step of aggregating the traffic statistical information acquired in the sixth step for each of the one or more flows and for each aggregation period;
an eighth step of generating traffic variation notification information when detecting the traffic variation based on the traffic statistical information acquired in the sixth step; and
a ninth step of transmitting the traffic statistical information and the traffic variation notification information aggregated for each flow to the data accumulation device.

15. The traffic statistical information acquisition method according to claim 14, wherein the eighth step comprises:
calculating a difference between a latest traffic statistical information acquired in the sixth step and an immediately preceding traffic statistical information for each of the one or more flows; and
judging that the traffic variation occurs when the difference exceeds a predetermined threshold value.

16. The traffic statistical information acquisition method according to claim 14, wherein the second step comprises:
a tenth step of receiving the traffic statistical information and the traffic variation notification information transmitted from the data collection device; and
an eleventh step of classifying the traffic statistical information and the traffic variation notification information received in the tenth step for each of the one or more flows and to register the traffic statistical information and the traffic variation notification information in the database by a corresponding flow of the one or more flows.
